(19) United States
(12) Patent Application Publication
(10) Pub. No.: US 2011/0052412 A1
(43) Pub. Date: Mar. 3, 2011

(54) HIGH-PRESSURE TURBINE ROTOR, AND METHOD FOR THE PRODUCTION THEREOF

(75) Inventors: Christoph Ader, Muenchen (DE); Karl-Heinz Dusel, Unterschleissheim (DE); Roland Huttner, Jesenwang (DE); Steffen Schlothauer, Karlsfeld (DE)

(73) Assignee: MTU Aero Engines GmbH, Munich (DE)

(21) Appl. No.: 12/446,211

(22) PCT Filed: Oct. 10, 2007
(86) PCT No.: PCT/DE2007/001803

§ 371 Date: Nov. 8, 2010

(30) Foreign Application Priority Data
Oct. 18, 2006 (DE) 10 2006 049 216.1

(51) Int. Cl. F01D 5/18; B23P 15/04

(52) U.S. Cl. 416/97 R; 29/889.2

(57) ABSTRACT

A method for producing a high-pressure turbine rotor, as well as a turbine rotor, is disclosed. The turbine rotor is designed as a blisk (i.e., bladed disk) and forms a radially inward disk and several vanes or blades that project from the disk. The turbine rotor has an internal duct system for air cooling and at least one section of the turbine rotor is manufactured in a generative production process.

### BACKGROUND AND SUMMARY OF THE INVENTION

This application claims the priority of International Application No. PCT/DE2007/001803, filed Oct. 10, 2007, and German Patent Document No. 10 2006 049 216.1, filed Oct. 18, 2006, the disclosures of which are expressly incorporated by reference herein.

The invention relates to a method for production of a high-pressure turbine rotor designed as a blisk as well as such a high-pressure turbine rotor.

Until now rotors for high-pressure turbines of aircraft engines have been manufactured in such a way that the turbine vanes are individually inserted into a rotor base body. In this case, the turbine vanes are provided with complex internal ducts for cooling the rotors or vanes. The individual, inserted vanes are each manufactured of precision castings, wherein, particularly in the case of hollow vanes, wax models with ceramic cores are used. These types of bladed rotors for high-pressure turbines of the known type have a plurality of individual parts and are also expensive to manufacture.

With this as the background, the invention is based on the objective of producing a high-pressure turbine rotor or such a high-pressure turbine rotor which can be manufactured simply and cost-effectively.

The high-pressure turbine rotor or the inventive high-pressure turbine rotor manufactured by means of the inventive method therefore has a rotor base body with a plurality of turbine vanes formed thereon. The turbine vanes have a duct system, which is provided in the interior of these turbine vanes for tempering same.

To manufacture this high-pressure turbine rotor, at least the vanes thereof are constructed by means of a generative production process. This is accomplished in particular in that the vanes are constructed in layers. This may be such that suitable sinterable powders, which, for example, have a distinct semi-solid state, are applied, and solidified in the areas in which solid material of the vane is supposed to develop. In this case, it may be provided that there is no solidification in the area of the respective ducts in the layered cross sections so that subsequently the powder in these areas may be blown out to form the corresponding ducts.

The inventive high-pressure turbine rotor is a blisk in particular and this applies correspondingly with respect to the high-pressure turbine rotor that is manufactured with the inventive method in an advantageous embodiment. This type of blisk (bladed disk) is in particular such that it is comprised of a disk and plurality of vanes formed thereon, wherein the disk and the vanes are connected as one piece. It may be provided that the design of the rotors in the turbine is embodied as a single-stage blisk, or as multi-stage blisk; this may take place in particular in a manner analogous to a compressor. It may be provided that the vanes and the vane segment(s) be manufactured individually in a generative manner. Furthermore, it may be provided that this or the structure of the vanes or of the vane segment(s) be accomplished in final contour or with an allowance in order to subsequently be abrasively finish-machined. It may be provided that the individually manufactured vanes be connected to the respective disk segments or the disk using a suitable joining method, such as for example, welding, soldering, to form a (turbine) blisk.

However, it may also be provided that the disk with the vanes, i.e., in particular all parts of the blisk, which in this case is a turbine blisk in particular, be produced in a generative production process. In other words, the disk of a (turbine) blisk as well as vanes may be manufactured using an appropriate powder in a generative production process in such a way that subsequent joining or connecting of the vanes to the disk (or corresponding segments) becomes superfluous or unnecessary.

Irrespective of this, it may also be provided that both the disk of a (turbine) blisk as well as the vanes of a (turbine) blisk each be manufactured generatively, and subsequently be joined or connected with a suitable joining method, which may be of the aforementioned type for example.

The (turbine) blisk or the high-pressure turbine rotor designed as a (turbine) blisk may be embodied with free-standing vanes; but it may also be provided that the vanes or vane segments be manufactured or connected with an outer cover band and, particularly at these locations, also be joined. This may take place, for example with a suitable joining method, such as welding or soldering.

An especially preferred embodiment provides that the complete (turbine) blisk, i.e., particularly disk and vanes, be produced generatively. It may be provided that within the production or construction process, different materials be processed or the (turbine) blisk or the high-pressure turbine rotor be constructed or comprised of different materials. In addition, it may be provided that variable material properties be produced by corresponding parameter adjustment and process management. This may be in particular such that the material properties are embodied in a graduated manner or that they change over the high-pressure turbine rotor or the (turbine) blisk; this may also be in particular such that the material properties change over individual vanes and/or over the disk of the (turbine) blisk, i.e., depend upon the spatial position or a respective two-dimensional or three-dimensional position.

For example, it may be provided that different materials be used or employed for the vanes or blades and the (turbine) blisk disk, or that these are made of different materials.

It may also be provided that during the construction or production process, a tip armoring is applied or applied to the vane tips; the application of a tip armoring may also take place in particular by a corresponding generative construction or in the course of a generative construction.

Furthermore, it may be provided that a coating, in particular a ceramic coating, be applied during or in the course of the construction process or production process of the (turbine) blisk or of the vane of the blisk or the blades of the blisk. This type of coating, which as addressed is a ceramic coating in an advantageous embodiment, may be applied to the disk and/or to the vanes or blades, or is partially applied. This type of ceramic coating may be, for example, an anticorrosive layer or a high-temperature protective layer or the like. It may be provided that such a layer—partial or complete as the case may be—is only applied to the blades or to the vanes or only to the disk of the (turbine) blisk, or to both the disk as well as to the vanes or blades of the (turbine) blisk.

As mentioned above, it may be provided that both the disk of the (turbine) blisk as well as the vanes of the (turbine) blisk or the vane ring be constructed or manufactured generatively.

However, it may also be provided that the disk, which as a rule is highly stressed, be manufactured conventionally from a forged blank and the vane ring or the vanes or the vane segments be constructed or manufactured generatively. It may be provided that the construction of the vane ring of the vanes or the vane segments be accomplished in final contour or with an allowance in order to subsequently be abrasively finish-machined.

The vane ring or the vane segments or the individual manufactured vanes is or are connected to the disk in an advantageous embodiment using a suitable joining method, such as for example, welding or soldering.

As already addressed, it is provided in particular that the turbine blisk or the high-pressure turbine rotor, and in particular the vanes or blades of this turbine blisk or this high-pressure turbine rotor, be equipped with an internal (cooling) duct system for an air flow for cooling. In this case, this duct system is manufactured in particular generatively in the course of the construction of the blades or the construction of the blisk or the construction of the disk or the disk segment.

It may be provided that the design of the vanes be accomplished generatively directly on a finished or pre-processed space. The structure of the vanes may be accomplished in final contour or with an allowance in order to subsequently be abrasively finish-machined and/or using metal cutting. It may also be provided that the disk of the blisk feature integrated radial flow compressor structures. Particularly because of the radial flow compressor structures integrated into the disk, an additional boost and increase in the air flow is possible, which may be used for more effective cooling.

Because of the layered construction process, there is for example the possibility of introducing hollow structures (e.g., for tempering) or load-capable internal structures. The complex internal ducts do not have to be manufactured using molding processes, but may be left open with the generative layer structure or are constructed together with it. In the case of methods using material supply, the ducts remain free in accordance with the CAD model, with construction in a powder bed, the powder is not solidified at the location of the ducts and is subsequently blown out.

As indicated in the foregoing, it is also provided that, using a CAD model of the to-be-manufactured blisk or of the to-be-manufactured turbine rotor or of the to-be-manufactured vanes or of the to-be-manufactured disk of the blisk, the respective affected aforementioned part is manufactured, and namely in particular taking a duct system into consideration, which is supposed to be produced in the course of producing the interior of the respective affected component.

It may be provided that the area, in which the solid material is supposed to be produced in the course of manufacturing, is correspondingly irradiated from the powder bed—for example by means of a laser of another radiation and/or light source—and the area, in which the ducts are supposed to develop, is correspondingly not irradiated or hardened. In this case, it may be provided that upon completion of the to-be-hardened sections, the powder that has remained in the formed ducts is blown out.

In an advantageous embodiment, the design of the structures is accomplished in layers starting from CAD data. For this purpose, all so-called prototyping methods, with which metal components may be constructed, may be used for example. The construction may take place using sinterable powder using a beam source in a natural or artificial environment (e.g., atmosphere, inert gas, vacuum).

The following methods may be used for example as methods for production: Laser engineered net shaping (LENS; e.g., Optomec, Co. www.optomec.com) and/or electron beam melting (e.g., Arcam Co., www.arcam. de) and/or direct laser metal sintering (e.g., EOS, Co., www.eos-gmbh.de) and/or selective laser melting (e.g., Fraunofer ILT, Trumpf Co., www.fraunhofer.de) and/or laser forming (e.g., TrumaForm, Trumpf Co., www.Trumpf.com) and/or deposition laser welding (e.g., Trumpf, Co.).

The use of generative fabrication technologies makes it possible to generatively construct to a large extent any defined three-dimensional structures. Generative production processes may basically be used on all metallic materials used in building engines (e.g., titanium and/or nickel alloys). Suitable are for example sinterable powders, which have a distinct semi-solid state.

In particular, complex internal ducts, such as those required for the cooling of rotors, for example, may be realized in the high-pressure turbine by a complete generative production of the rotors, or this is undertaken in an advantageous embodiment of the invention.

Structures with internal frameworks as well as a closed outer skin may be manufactured in particular in an advantageous embodiment. Because the geometry is established starting directly from the CAD data in an advantageous embodiment, there exists almost unlimited freedom of design in this case.

Use may be aimed for example at housing structures in engine technology, which must be devised structurally in such a way that the internal structure is designed, depending upon requirements, from a structural mechanical point of view as well as possible or as optimally as possible (e.g., rigid, damping), something which may mean the lowest possible weight for example.

The freedom of design may also be used for example to allow gas or liquid to flow through the existing hollow structures so that tempering or sound insulation may be achieved.

It is provided in particular that metallic bodies or a (turbine) blisk be structured in layers directly from a CAD model. The method is suitable in particular for every meltable material, and namely for metallic material in particular. In a preferred embodiment a nickel-based alloy or a titanium alloy or stainless steel is used as the material.

In an advantageous embodiment, the disk and the vanes of the turbine blisk are integral in one component with optional formed hollow cavities, in particular cooling structures.

Several advantages and exemplary effects are explained in the following, which at least may be given or are given with advantageous further developments of the invention. However, it must be noted in this connection that all of these advantages or these advantages do not necessarily have to be present in every inventive embodiment.

For example, a reduction in weight may be achieved. In addition, the number of parts may be reduced for example. Furthermore, costs and/or emission may be reduced.

A further advantage is that is has become possible for the first time because of the invention to create suitable turbine blisks for practice or for mass production.

For a fairly long time, the widest variety of manufacturers has aspired to create turbine blisks. However, until now it has not been possible to realize this in a manner that has actually been proven for practice in a suitable way and that is suitable for mass production in particular. Because of the present invention, it is now possible for the first time to create turbine blisks, which may be used without hesitation in practice, for example also in mass production, without being extremely expensive in the process.

A further advantage of the invention or a preferred embodiment of the invention is that, in addition to complex external contours, hollow structures may also be constructed.

### BRIEF DESCRIPTION OF THE DRAWINGS

It should be explained in the following on the basis of the figures, how an inventive method may be embodied or an exemplary inventive object may be manufactured, wherein, however, the invention should not be restricted thereby. The drawings show:

FIG. 1 illustrates the exemplary steps of an exemplary inventive method;

FIG. 2 illustrates an exemplary construction process for an exemplary inventive object or for executing an exemplary inventive method; and

FIG. 3 illustrates exemplary sample components.

### DETAILED DESCRIPTION OF THE DRAWINGS

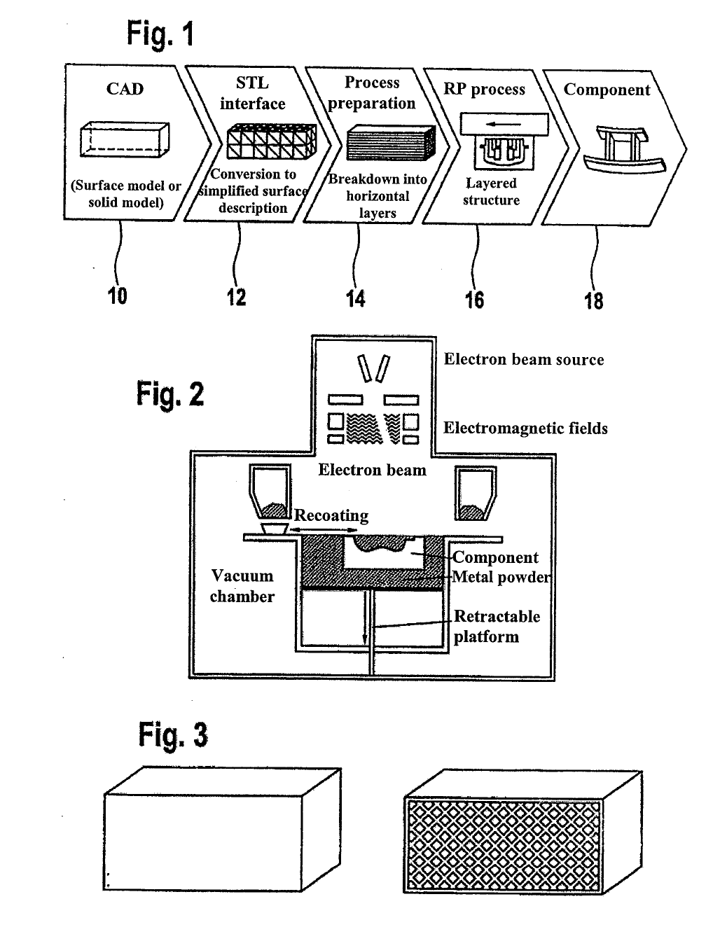

FIG. 1 shows an exemplary flow of an exemplary inventive method, with which the turbine rotor designed as a blisk may be manufactured for example. First of all, a surface model or solid model is provided by means in CAD in step 10.

Then the model is converted into a simplified surface description (step 12). The process is prepared in step 14, wherein, to do so, in particular the surface description or the model is broken down into horizontal layers. In step 16 an RP process is conducted or a layered structure is accomplished. Finally, the component or the turbine blisk is finished (step 18). An inventive preferred component may therefore be manufactured with this generative fabrication process (rapid prototyping) that was explained on the basis of FIG. 1.

FIG. 2 shows an exemplary construction process of a so-called electron beam melting (Arcam Co.).

FIG. 3 shows a schematic representation of sample components, wherein a compact material structure is depicted on the left and a hollow structure to be manufactured generatively is depicted on the right.

1-8. (canceled)

9. A method for producing a turbine rotor, wherein the turbine rotor is designed as a blisk and forms a radially inward disk and vanes or blades that project from the disk, and wherein the turbine rotor has an internal duct system for air cooling, comprising the steps of:
manufacturing at least one section of the turbine rotor in a generative production process.

10. The method according to claim 9, wherein the turbine rotor is a high-pressure turbine rotor.

11. The method according to claim 9, wherein the disk and/or the vanes or the blades are manufactured in the generative production process.

12. The method according to claim 11, wherein all vanes or blades of the turbine rotor are manufactured in the generative production process.

13. The method according to claim 9, wherein the turbine rotor is manufactured completely or in areas by the generative production process using a CAD model.

14. The method according to claim 9, wherein the turbine rotor is constructed by the generative production process completely or in areas from a powder bed.

15. The method according to claim 14, wherein a powder of the powder bed in areas in which internal ducts of the turbine rotor are formed is not solidified and wherein the non-solidified powder is subsequently blown out.

16. The method according to claim 9, wherein material is supplied for the generative production process of the turbine rotor and wherein areas in which internal ducts of the turbine rotor are formed remain free of the material according to a CAD model.

17. A turbine rotor, wherein the turbine rotor is a blisk, comprising a radially inward disk and vanes or blades that project from the disk, wherein the disk and/or vanes and/or blades have an internal duct system for air cooling, and wherein at least one section of the turbine rotor is manufactured in a generative production process.

18. The turbine rotor according to claim 17, wherein the turbine rotor is a high-pressure turbine rotor.
